(19) United States
(12) Patent Application Publication
(10) Pub. No.: US 2006/0188769 A1
(43) Pub. Date: Aug. 24, 2006

(54) Method and apparatus for dielectric isolation of fuel cells

(75) Inventors: Randolph M. Bernard, New Preston, CT (US); Jeffrey Peter Allen, Naugatuck, CT (US); Peter Wilcox Allen, Southbury, CT (US)

Correspondence Address: BANNER & WITCOFF, LTD., 28 STATE STREET, 28th FLOOR, BOSTON, MA, 02109-9601, US

(73) Assignee: GenCell Corporation, Southbury, CT (US)

(21) Appl. No.: 11/361,684

(22) Filed: Feb. 24, 2006

Related U.S. Application Data
(60) Provisional application No. 60/655,990, filed on Feb. 24, 2005.

(51) Int. Cl. H01M 2/02

(52) U.S. Cl. 429/34

(57) ABSTRACT

Embodiments of the present invention are directed to fuel cell enclosures separate by a dielectric joint. The dielectric joint includes a flange portion from respective housing sections. A dielectric material is positioned between the respective flanges. Removable fasteners are used to secure the flanges and housing sections together.

### CROSS-REFERENCE TO RELATED APPLICATION(S)

This application claims priority to U.S. Provisional Patent Application No. 60/655,990 filed Feb. 24, 2005 hereby incorporated by reference in its entirety for all purposes.

### FIELD OF THE INVENTION

This invention relates to fuel cell stacks and in particular to methods for separating the positive pole of a fuel cell stack from the negative pole of the fuel cell stack using a dielectric material.

### BACKGROUND

An electrochemical fuel cell converts the chemical bond energy potential of fuel to electrical energy in the form of direct current (DC) electricity. Fuel cells are presently being considered as replacement for battery storage systems and conventional electric generating equipment.

An electrochemical fuel cell stack is formed of a plurality of individual fuel cells, each possessing a positive (+) and a negative (−) electrical pole, arranged in an electrical series relationship to produce higher useable DC voltage potential. A DC/AC inverter may be utilized to convert the DC electrical current to AC electrical current for use in common electrical equipment. Various sensors may be inserted into any of the plurality of individual fuel cells for data acquisition and system control.

The major positive and negative electrical poles at the end plate terminals are desirably dielectrically separated from one another to maintain an open electric circuit in order for the fuel cell to function properly. A short circuit between the electrical poles, or between any other positions on the fuel cell stack that have an electronic potential generated by the electrochemical fuel cell reaction, will draw down the fuel cell electrical potential and will reduce the output power and the electrical efficiency of the fuel cell.

The electrical resistance of short circuits will vary depending on many factors such as location, source of the shorting component i.e. thermocouple, surface area involved, surface conductivity, etc. Short circuits that have relatively high electrical resistance, hereinafter referred to as a “partial-short,” may permit the continued operation of the fuel cell, albeit at a reduced quality. Short circuits that have very low electrical resistance, hereinafter referred to as a “dead short,” will likely totally prevent operation of the fuel cell.

For high-electrical-resistance partial-short circuits the reactant flow rate may be increased to off-set the short-circuit-induced reactant consumption. However, the increase in reactant flow rate will reduce the electrical efficiency of the fuel cell.

Excessively high reactant utilization may result in damage to the fuel cell by reducing the oxygen or hydrogen concentrations in the reactant gas streams. Reduced oxygen or hydrogen concentrations will alter the oxidizing and reducing qualities of the environments of the cathode and the anode chambers that may lead to accelerated corrosion, mechanical creep, particle-to-particle sintering and other undesirable reactions that will reduce the useful life of the short-circuited fuel cell.

The additional electrochemical reaction supporting the partial-short will produce additional heat that must be removed from the fuel cell. In some instances, heat removal becomes a dominant limiting factor at high power operation of fuel cell stacks. A partial-short may reduce the total output power of the fuel cell by overwhelming the fuel cell stack cooling system at high power levels.

Partial shorts may be created during stack assembly or during stack operation when, for example, sensors within the fuel cell shift and contact electrically live surfaces. Partial-shorts may burnout immediately after being made, or shortly thereafter, due to the heat produced by carrying the current.

Various sensors such as thermocouples and voltage leads that are commonly inserted into the fuel cells may also commonly be required to penetrate the wall of a reactant manifold or stack enclosure/housing in order to access openings in the individual fuel cells. A common prior art method of penetrating manifolds or housings is through special fittings. Special fittings that dielectrically isolate the sensors as they pass through the manifold/housing wall are commercially available under the trademark CONAX™ and are often configured to promote a concentration of sensors at the point of penetration through the manifold or housing wall. This concentration significantly increases the possibility that short-circuits will be created.

Dead-shorts are capable of carrying the full output current of the fuel cell stack. Dead-shorts will drive the stack voltage potential to 0.0 VDC nearly instantaneously. Dead-shorts will typically comprise a short circuit between the major end plate terminals of the fuel cell stack and may involve other hardware components such as externally attached reactant gas manifolds and piping systems that exist elsewhere in the operating system within which the fuel cell stack is installed.

External manifolds are a common method of introducing one or more reactants to the fuel cell stack. These are open-face box-like manifolds that are fastened to the major external surfaces of the fuel cell stack. External manifolds may be formed of conductive materials such as stainless steel. In these instances, it is desirable that the external manifold be dielectrically isolated from the major surface of the fuel cell stack to which it is fastened.

U.S. Pat. No. 6,670,069, incorporated herein by reference in its entirety for all purposes, describes a fuel cell stack assembly that includes a housing having a first half-shell and a second half-shell and a dielectric spacer. However, the dielectric spacer is located between one end of the fuel cell stack and an interior wall of housing section.

It is well known in the art that liquid electrolyte, such as molten carbonate liquid electrolyte in molten carbonate electrolyte fuel cells (MCFC's), migrates over the surfaces of the fuel cell stack and the enclosures and/or manifolds. It is further well known in the art that migratory liquid molten carbonate electrolyte can present significant engineering challenges such as excessive loss of electrolyte, surface corrosion and contribute to the creation of short circuits.

Migratory molten carbonate electrolyte that bridges across dielectric spacers may contribute to the creation of dead-short circuits. These electrolyte-induced dead-shorts may produce electrical arcing. This arcing is particularly susceptible in fuel cell stacks that are comprised of numerous cells producing very high electrical potentials. Without wishing to be bound by theory, it is believed that electronic arcing initiated at the sites of electrolyte saturated migration routes produces heat sufficiently high as to melt the stainless steel comprising the housings and the manifolds of molten carbonate fuel cell stacks. Molten-metal-producing-arcing is thought to further contribute to the creation of additional dead-shorts and partial-shorts from the spatter of droplets of molten metal. The process may propagate to produce large holes in sheet metal housings and manifolds. The large holes result in excessive loss of reactant from within the housings or manifolds and result in premature failure of the fuel cell stack.

Another aspect of dielectric isolators such as primary stack dielectric spacers is the requirement to address the differential thermal expansions that are common in high temperature fuel cells such as the MCFC's. Materials suitable for dielectric spacers for high temperature fuel cells typically have a significantly lower coefficient of thermal expansion than the materials comprising the manifolds, housings and individual cells of the stack. In instances where large-surface-area cells are utilized there can be very significant differentials of expansion that must be addressed to avoid the development of various failure modes such as short-circuits, reactant leakage and various mechanical distortions.

The prior art designs for the apparatus and methods for dielectrically isolating box-type external manifolds from the electrical poles of a fuel cell stack as well as the dielectric isolation of sensors penetrating the housings and manifolds of fuel cell stacks in general and of high-temperature fuel cell stacks in particular do not adequately address the critical requirements for the avoidance of short-circuits. Therefore, it is desirable to provide an improved fuel cell stack housing and dielectric isolation for fuel cell stacks. It is also desirable to provide an improved method for the penetration of the housing and manifolds of fuel cell stacks by the signal conductors of sensors.

It is an object of the present invention to provide a dielectric isolator that reduces or wholly overcomes some or all of the difficulties inherent in prior known devices. Particular objects and advantages of the invention will be apparent to those skilled in the art, that is, those who are knowledgeable or experienced in this field of technology, in view of the following disclosure of the invention and detailed description of preferred embodiments.

### SUMMARY OF THE INVENTION

Embodiments of the present invention are directed to fuel cell stack housing assemblies which provide for the dielectric isolation of fuel cell stacks. Aspects of certain embodiments of the present invention are particularly advantageous in that they reduce the occurrence of short circuits than can result between the electrical poles, or between any other positions on the fuel cell stack that have an electronic potential generated by a fuel cell reaction. Such short circuits can be disadvantageous in that they tend to draw down the fuel cell electrical potential thereby reducing the output power and the electrical efficiency of the fuel cell.

In accordance with certain aspects of the present invention, a fuel cell stack, such as those well known to one of ordinary skill in the art, having a negative electrical pole end and a positive electrical pole end is contained within a housing having a first housing section and a second housing section. The housing sections are respectively in electrical contact with an electrical pole of the fuel cell stack. For ease of reference in describing the invention, the first housing section is electrically connected to the negative electrical pole end and the second housing section is electrically connected to the positive electrical pole end. The first and second housing sections are fixedly connected to one another and dielectrically separated from one another. According to one embodiment of the present invention, a dielectric medium is placed between the first and second housing sections at locations where the first and second housing sections are to be secured together. Accordingly, the dielectric medium may be understood as acting as a gasket between the first and second housing sections and thereby physically separating the first and second housing sections so that they do not physically contact one another.

According to one embodiment of the present invention, the first and second housing sections each include respective flanges angled outwardly and to the exterior of the housing section. The flanges are connected opposite to one another to form the housing for the fuel cell stack. Positioned between the flanges is a dielectric medium. Together the flanges and the dielectric medium form a dielectric joint between the first and second housing sections. In accordance with one aspect, the position of the opposing flanges and dielectric medium, which can be in the form of a strip, relative to the major un-grounded electrical terminal of the fuel cell stack is selected to eliminate the influence of migratory liquid electrolyte on the dielectric qualities of the dielectric joint.

The dielectric medium, referred to alternatively as a spacer, may be fashioned from a non-conductive ceramic for high temperature fuel cells, or non-conductive plastic for low temperature fuel cells, and may be substantially dense and non-porous. Methods of making dielectric media are well known to those of skill in the art. In certain preferred embodiments, the dielectric spacer may consist of a single pre-fired cast ceramic material in the desired geometry. In other preferred embodiments, the dielectric spacer may be a single non-fired, or green, ceramic material in the desired geometry. Alternatively, the dielectric spacer may be a single or multiple non-fired, or green, ceramic material in the desired geometry produced with conventional tape casting equipment. According to alternate embodiments, the dielectric spacer may be shaped, stamped or cut into a desired geometry when using solid materials such as mica. Dielectric spacers are formed having sufficient thickness to be suitable as dielectric media, which according to the present invention can be within the range of about 0.25 inches to about 0.5 inches.

According to a certain aspect of the present invention, the first and second housing sections are removably secured to one another. This is advantageous should the fuel cell stack need repair or the dielectric medium need replacing. According to one embodiment, the first housing section flange and the second housing section flange are removably connected to one another by a plurality of removable fasteners. The removable fasteners are positioned through the first housing flange, the dielectric medium and the second housing flange. According to one aspect, the fasteners are equipped with dielectric bushings and washers to further improve the dielectric nature of the dielectric joint. The fasteners are configured to improve the sealing quality of the flange and dielectric medium forming the dielectric joint. According to one embodiment, it is advantageous for the openings in the dielectric medium through which the fasteners extend to be larger than the diameter of the fasteners. This configuration provides a tolerance that allows the fasteners and dielectric medium to respond to structural changes in the fuel cell that may result during its operation, for example. According to another embodiment, the dielectric joint configuration can include backing strips contacting and otherwise reinforcing the outer surface of each flange. The backing strips are formed from materials known to those skilled in the art to withstand the operating conditions of the fuel cell and to distribute the forces applied by the fasteners onto the surface of the dielectric strip so as to further improve the sealing quality of the dielectric joint.

A dielectric medium according to aspects of the present invention can be integral or unitary, much like a gasket, or in the form of a single strip. Also, a dielectric medium can include separate adjacent portions or strips either contacting each other or being spaced apart or a combination of both to provide tolerances that allow the dielectric medium to respond to structural changes in the fuel cell during its operation, for example. In accordance with yet another aspect, the strip of dielectric material is separated into substantially straight sections of uniform length and corner sections in an angled configuration. The penetrations for the fasteners through the opposing flanges and the dielectric strip are elongated to provide the ability for differential motion to occur relative to the opposing flanges and the dielectric strips.

The end sections of the separate adjacent portions of the dielectric medium can be parallel to one another or they can have configurations that allow them to be positioned adjacent to one another in mating fashion. Such configurations can include a single male-female extension-slot configuration, key-slot configuration or dovetail configuration having more than one extension-slot configuration. With these configurations, any leak path for reactants would be extended or otherwise torturous and thereby limiting or reducing the effects of such leak paths and improving the sealing quality of the dielectric joint while providing tolerance or space for differential motion which may result from differential thermal expansions and contractions of both the dielectric strip and the opposing flanges of the housing.

According to a certain aspect of the present invention, the dielectric medium provides an entry point into the interior of the housing and accordingly into the fuel cell stack. This is advantageous for the placement of sensors within the fuel cell stack or for the introduction or removal of substances, materials, gases etc., from the fuel cell stack for monitoring, analysis, refueling etc. According to one embodiment, a plurality of openings are included through the dielectric medium with the openings connecting the exterior of the fuel cell housing with the interior of the fuel cell housing. Electrical leads connecting a sensor interior to the fuel cell stack, or fuel cell generally, can be threaded through or otherwise placed in the openings so that monitoring of the operation of the fuel cell stack can be achieved. Alternatively, tubes can be threaded through or otherwise placed in the openings so that materials, substances, gases, etc. can be introduced or removed from the fuel cell stack or interior of the fuel cell generally. Sensors of the type described here are well known to those of skill in the art and can include temperature sensors, chemical sensors, pressure sensors and the like. The openings or otherwise penetration points through the dielectric medium are distributed at a frequency along the edge of the dielectric strip that represents a significant distance between adjacent sensors. Significant distances may range from about a minimum of about 0.25″ to 0.50″ such that the possibility for short-circuits between sensors is significantly reduced.

### BRIEF DESCRIPTION OF THE DRAWINGS

Certain aspects of the invention will become apparent upon reading the following detailed description in conjunction with the accompanying drawings, in which:

FIG. 1 is an isometric cutaway of a fuel cell stack within a dielectrically isolated enclosure.

FIG. 2 is a cross-section of a dielectric break.

FIG. 3 is a plan view of a dielectric break installed on an enclosure.

FIG. 4 illustrates a cross-section taken at line AA of FIG. 3.

FIG. 5 illustrates a plan view of a dielectric strip.

FIG. 6 is an isometric cutaway of a fuel cell stack within a dielectrically isolated enclosure with sensors and conduits penetrating the enclosure through apertures within a dielectric strip.

The figures referred to above are not drawn necessarily to scale and should be understood to present a representation of the invention, illustrative of the principles involved. Some features depicted in the drawings have been enlarged or distorted relative to others to facilitate explanation and understanding. Methods and devices for the dielectric isolation of fuel cell stacks from the reactant manifolds as disclosed herein, will have configurations and components determined, in part, by the intended application and environment in which they are used.

### DETAILED DESCRIPTION OF EMBODIMENTS

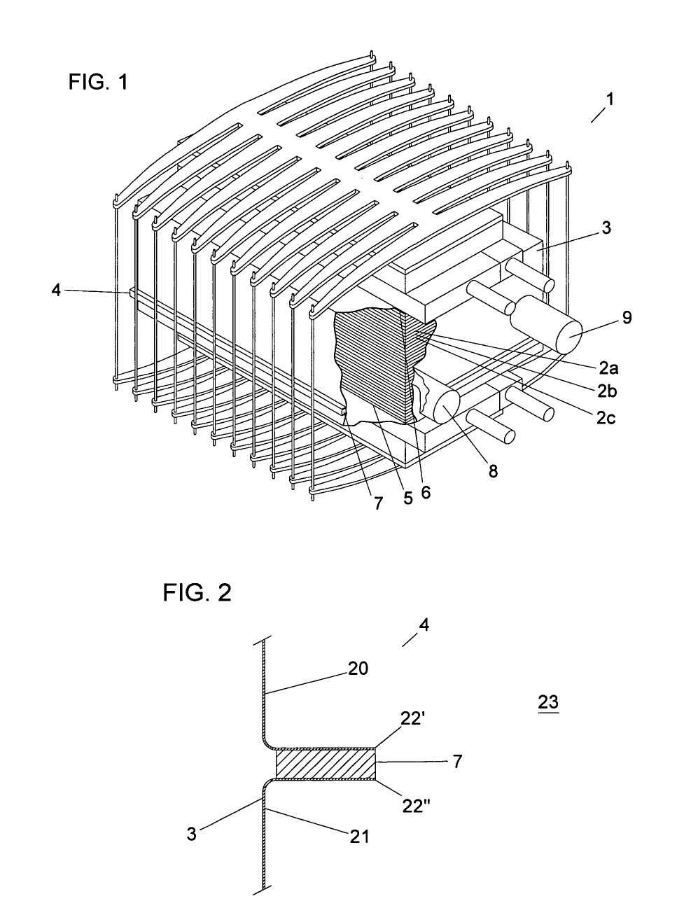

FIG. 1 illustrates a fuel cell stack 1 such as a fuel cell stack described in U.S. Pat. No. 6,670,069 hereby incorporated by reference in its entirety for all purposes. The fuel cell stack 1 includes a plurality of individual cells represented by 2a, 2b, 2c stacked upon one another. The fuel cell stack 1 is positioned within an enclosure 3 such that the fuel cell stack is substantially or entirely enclosed within the enclosure. Configurations and dimensions for enclosures are known to those of skill in the art and include those described in U.S. Pat. No. 6,670,069. The enclosure is configured to be in fluid communication with external inlet manifolds and external outlet manifolds of the plurality of individual fuel cells represented by 2a, 2b, 2c. As can be seen in FIG. 1, the enclosure is contacted by a compression assembly having an upper plate and a lower plate with the upper plate and lower plate being connected by plurality of fastening elements. Compression assemblies, in general, are known to those of skill in the art. The compression assembly shown in FIG. 1 is more fully described in pending U.S. application Ser. No. ______ entitled Fuel Cell Stack Compression Assembly filed Feb. 14, 2006 and hereby incorporated by reference in its entirety for all purposes.

As can be seen in FIG. 1, the periphery or circumference of the enclosure 3 is equipped with a dielectric joint 4 that electronically isolates the positive end cell 5 from the negative end cell 6 of the fuel cell stack 1 into a first housing section and a second housing section. The dielectric joint 4 includes a dielectric strip 7 using any of the materials known to those skilled in the art to be compatible with the operating conditions of the particular fuel cell to which the dielectric joint 4 is applied. Such materials include plastics, glass, rubber, alumina, mica, zirconia, ceria, etc., and the like or combinations or mixtures thereof. The dielectric joint 4 is positioned so as to electronically isolate the inlet aperture 8 and outlet aperture 9 of the enclosure 3 from the positive end cell 5 such that the end cell 5 is isolated from the major piping systems that exist elsewhere in the operating system within which the fuel cell stack is installed. The dielectric joint 4 is further positioned so as to physically isolate the dielectric strip 7 from migratory liquid electrolyte.

FIG. 2 illustrates a cross-section of the dielectric joint 4 where it is seen that enclosure 3 is divided into two parts at the dielectric joint 4. Upper enclosure 20 and lower enclosure 21 are provided with opposing flanges 22′, 22″ to engage with dielectric strip 7 and seal the interior of enclosure 3 from the ambient atmosphere 23. The opposing flanges are shown generally extending perpendicularly from the housing and outwardly. The upper and lower flanges are generally co-extensive however alternate configurations which maintain the dielectric medium and provide sealing characteristics will become apparent to one of skill in the art in view of the present disclosure.

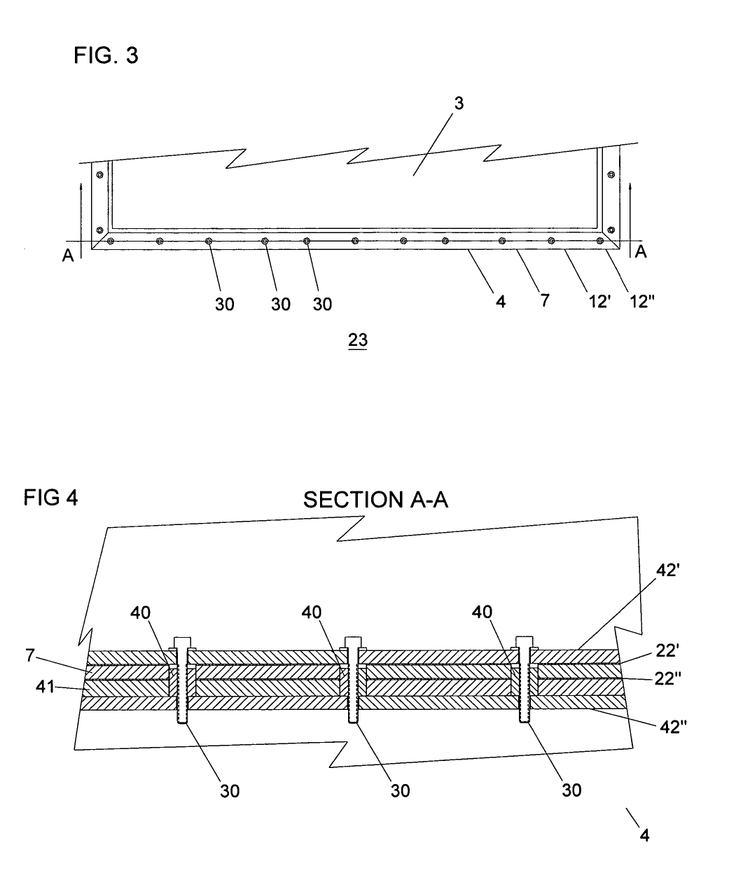

According to an aspect of the present invention illustrated at FIG. 3, a plurality of fasteners represented at 30 are provided, such as those fasteners known to those skilled in the art to be compatible with the operating conditions of the particular fuel cell to which the dielectric joint 4 is applied such as screws, nuts, bolts, rivets, clasps, etc. and the like, to optionally penetrate the dielectric strip 7 and opposing flanges 12′ and 12″, corresponding to flanges 22′ and 22″ of FIG. 2. The fasteners 30, and fasteners within the scope of the present invention generally, provide a compressive force to the dielectric joint 4 to improve upon the seal between the interior of enclosure 3 from the ambient atmosphere 23.

FIG. 4 illustrates a cross-section of dielectric joint 4 taken at line AA of FIG. 3. Fasteners 30 when including conductive materials such as metals require additional dielectric isolation provided by dielectric bushings 40 and dielectric spacer 41. The frequency of fasteners 30 is selected to uniformly apply the compressive sealing force to the dielectric joint 4. In instances where the thickness and strength of the opposing flanges 22′, 22″ is low, back-up strips 42′, 42″ are utilized to uniformly distribute the forces of the fasteners 30 to the dielectric joint 4. The material for the dielectric bushings 40 and the dielectric spacer 41 is selected from those groups of materials known to those skilled in the art to be compatible with the operating conditions of the particular fuel cell to which the dielectric break 4 is applied such as plastic, glass, rubber, alumina, mica, zirconia, ceria, etc. and the like or combinations or mixtures there of. The material for the back-up strips 42′, 42″ is selected from those groups of materials known to those skilled in the art to be compatible with the operating conditions of the particular fuel cell to which the dielectric joint 4 is applied such as steel, stainless steel, plastics, reinforced plastics, ceramics, etc. and the like or combinations or mixtures thereof.

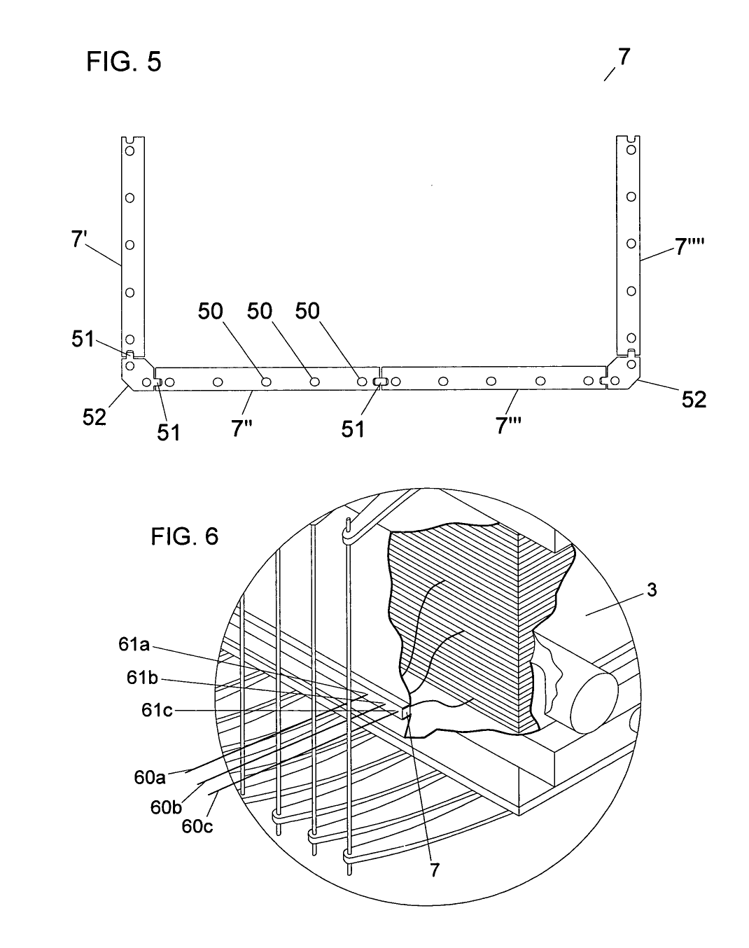

FIG. 5 illustrates a plan view of the dielectric strip 7. In instances where the dimensions of the fuel cell stack 1 and the enclosure 3 are large and the operating temperature of the fuel cell stack 1 and the enclosure 3 is high relative to ambient temperature, components of the fuel cell may expand or otherwise shift or move during operation. Embodiments of the present invention advantageously provide dielectric strip configurations which provide tolerance for differential expansions, such as differential thermal expansions, of components including the enclosure and the dielectric joint thereby providing desirable sealing and fastening characteristics of the dielectric joint 4 due to the differential thermal expansions. FIG. 5 illustrates that dielectric strip 7 includes a plurality of separate sections or pieces 7′, 7″, 7′″, and 7″″ and having slots 50 allowing the penetration of fasteners 30 through dielectric strip 7 and through dielectric spacer 41. Slots 50 are of a dimension sufficient to permit relative motion of the dielectric bushings 40 in response to differential thermal expansions that occur between the opposing flanges 22′, 22″ of the enclosure 3 and the dielectric strips 7′, 7″, 7′″, 7″″. Further, it is seen that keyed joints 51 are provided at the interface of the plurality of dielectric strips 7′, 7″, 7′″, and 7″″. Keyed joints 51 maintain a tortuous leakage pathway for the reactant within the enclosure 3 in the event of differential thermal expansion induced relative motion between the opposing flanges 22′, 22″ and the dielectric strips 7′, 7″, 7′″, 7″″ that otherwise would result in gaps between adjacent dielectric strips 7′, 7″, 7′″, 7″″. Although FIG. 5 shows a single extension at each edge of angled component 52 and a single keyed joint 51, a plurality of extensions or keyed joint can be used at each interface between separate sections of the dielectric strip. Also, each dielectric strip section can have one or more extensions unitary with the section allowing a male-female mating between adjacent sections.

A corner dielectric section 52 is used to transition the dielectric joint 4 through the corner of the enclosure 3. The corner dielectric section 52 is equipped with unitary keyed joints 51 that maintain a tortuous leakage pathway for the reactant within the enclosure 3 in the event of differential-thermal- expansion-induced relative motion between the opposing flanges 22′, 22″ and the dielectric strips 7′, 7″, 7′″, 7″″ and the corner dielectrics 52′, 52″ that otherwise would result in gaps between adjacent dielectric strips 7′, 7″, 7′″, 7″″ and corner dielectrics 52′, 52″.

For simplicity of manufacture, the plurality of dielectric strips 7′, 7″, 7′″, 7″″ are identical and interchangeable and the plurality of corner dielectrics 52′, 52″ are identical and interchangeable.

FIG. 6 illustrates another particularly preferred embodiment where penetration through the enclosure 3 by various sensors or conduits represented by 60a, 60b, 60c may be performed through the dielectric strips 7′, 7″, 7′″, 7″″ or the corner dielectrics 52′ 52″. Conduits, such as tubes to convey gas samples to the exterior of the enclosure from individual cells, or conduits, such as the tubes used to replenish liquid electrolytes to individual cells such as described in commonly held U.S. patent application Ser. No. 10/808,684 incorporated herein in its entirety by reference, may be inserted into individual cells and routed to the exterior of the enclosure through apertures 61a, 61b, 61c. Voltage leads and thermocouples may be attached to the plurality of individual cells 2a, 2b, 2c and may be routed to the exterior of the enclosure through apertures 61a, 61b, 61c. The internal diameter of the apertures 61a, 61b, 61c may have a close fit with the outside diameter of the sensors and conduits. The apertures 61a, 61b, 61c may have a long passage through the dielectric strips 7′, 7″, 7′″, 7″″ and the corner dielectrics 52′, 52″ relative the cross-sectional annular space that exists between the inside diameter of the apertures 61a, 61b, 61c and the outside diameter of the sensors or conduits 60a, 60b, 60c. The ratio of the length of the penetration through the dielectric strips 7′, 7″, 7′″, 7″″ to the cross-sectional annular space may be high so as to provide a tortuous leak path for the reactant within the enclosure. In another particularly preferred embodiment a ratio of greater than 1500:1 establishes a sufficiently tortuous leak path as to render the flow rate of reactant leakage through the penetration to that level which is considered to be insignificant.

In a further preferred embodiment, the annular space surrounding the sensor or conduit passing through the dielectric may be potted with a sealant selected from those materials known to those skilled in the art to be compatible with the environment of the particular fuel cell to which the present invention is being applied. For example, potting sealants may be selected from the group that includes silicone, rubber, epoxy, ceramic-based adhesives, etc and the like.

Embodiments of the present invention described herein are illustrative of the principles of the present invention. Alternate and additional embodiments will become apparent to those of skill in the art based on the present disclosure.

1. A fuel cell comprising:
a fuel cell stack having a negative electrical pole end and a positive electrical pole end,
a housing enclosing the fuel cell stack and having a first housing section electrically connected to the negative electrical pole end and a second housing section electrically connected to the positive electrical pole end,
the first housing section and the second housing section being fixedly connected to one another and dielectrically separated from one another.

2. The fuel cell of claim 1 wherein the first housing section and the second housing section are dielectrically separated from one another by a dielectric medium contacting the first housing section and the second housing section.

3. The fuel cell of claim 2 wherein the dielectric medium contacts a first housing section flange and a second housing section flange.

4. The fuel cell of claim 3 wherein the first housing section flange and the second housing section flange are removably secured to one another and with the dielectric medium positioned between the first housing section flange and the second housing section flange.

5. The fuel cell of claim 2 wherein the first housing section includes an inlet aperture and an outlet aperture for connecting to a piping system and wherein the inlet aperture and the outlet aperture are dielectrically separated from the positive electrical pole end.

6. The fuel cell of claim 2 wherein the dielectric medium is isolated from migratory liquid electrolyte.

7. The fuel cell of claim 4 wherein the first housing section flange and the second housing section flange are removably connected to one another by a plurality of removable fasteners.

8. The fuel cell of claim 7 wherein the removable fasteners are positioned through the first housing flange, the dielectric medium and the second housing flange.

9. The fuel cell of claim 8 wherein the fasteners are positioned through the dielectric medium in openings larger than the diameter of the fasteners.

10. The fuel cell of claim 8 wherein the dielectric medium separating the first housing flange and the second housing flange is unitary.

11. The fuel cell of claim 8 wherein the dielectric medium separating the first housing flange and the second housing flange comprises a plurality of separate sections, with each section contacting an adjacent section or positioned a distance away from an adjacent section.

12. The fuel cell of claim 8 wherein the dielectric medium separating the first housing flange and the second housing flange comprises a plurality of separate sections, with each section separated a distance away from an adjacent section.

13. The fuel cell of claim 12 wherein the plurality of separate sections are positioned adjacent to one another in mating fashion.

14. The fuel cell of claim 2 wherein the dielectric medium includes a plurality of openings through the dielectric medium with the openings connecting the exterior of the fuel cell with the interior of the fuel cell.

15. The fuel cell of claim 14 further including an electrical lead positioned within the opening and connecting a sensor positioned within the fuel cell stack.

16. The fuel cell of claim 14 further including a tube positioned within the opening and connecting the fuel cell stack in a manner to introduce substances into or withdraw substances from the fuel cell stack.

17. A fuel cell comprising:
a fuel cell stack having a negative electrical pole end and a positive electrical pole end,
a housing enclosing the fuel cell stack and having a first housing section electrically connected to the negative electrical pole end and a second housing section electrically connected to the positive electrical pole end,
the first housing section and the second housing section being fixedly connected to one another and dielectrically separated from one another by a dielectric joint.

18. The fuel cell of claim 17 wherein the dielectric joint includes opposing flanges and a dielectric medium disposed between the opposing flanges.

19. The fuel cell of claim 18 further connecting elements disposed through the dielectric medium and connecting the exterior of the fuel cell with the interior of the fuel cell.

20. The fuel cell of claim 18 wherein the connecting elements are wires.

21. The fuel cell of claim 18 wherein the connecting elements are tubes.
